(19) United States
(12) Patent Application Publication
(10) Pub. No.: US 2002/0088906 A1
(43) Pub. Date: Jul. 11, 2002

(54) Cable holding means

(75) Inventors: Klaus Nothofer, Erkrath (DE); Hans-Detlef Leppert, Monchengladbach (DE); Hans-Jurgen Lysson, Korschenbroich (DE); Wolfgang Teschner, Wunstorf (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/038,670

(22) Filed: Jan. 8, 2002

(30) Foreign Application Priority Data
Jan. 9, 2001 (DE) 101 00 647.0

(51) Int. Cl. F16L 3/08

(52) U.S. Cl. 248/65; 248/74.1

(57) ABSTRACT

The invention relates to a cable holding means within a pipe (1) having at least one holding element, which is secured on the inside wall (2) of the pipe (1), and at least one clamping element (4), which is secured on the holding element for the purpose of receiving the cable (5) or the cable bundle. In order for the cable or cable bundle to be held simply and reliably even when the course of the cable is highly curved, it is provided for the clamping element (4) to be secured on the holding element such that it is rotatable about a radial axis of the pipe (1).

### BACKGROUND OF THE INVENTION

The invention is based on a priority application DE 101 00 647.0, which is hereby incorporated by reference.

The invention relates to a cable holding means within a pipe having at least one holding element, which is secured on the inside wall of the pipe and at least one clamping element, which is secured on the holding element for the purpose of receiving the cable or the cable bundle.

A generic cable holding means is disclosed in WO 99/42865. Here, the clamping element for receiving the cable is equipped in clip-like manner with two resilient holding tongues and is rigidly connected to the holding element. This arrangement is problematic in that tensile and bending forces produced when the cable is laid and tensioned can lead to mechanical overload of the cable and/or of the clamping element. Moreover, the cable can be inadvertently pushed out of the clamping element. These disadvantages are particularly significant in the case of cables which cannot be laid axially parallel to the pipe and in the case of curved pipes. A consistently axially-parallel installation of the cable is often impossible due to fittings inside the pipe or peripheral pipe connections, in particular junctions.

### SUMMARY OF THE INVENTION

The object of the invention is to eliminate these disadvantages and to provide a cable holding means which enables the cable to be secured reliably on the inside of the pipe in such a way that adaptations can be effected in accordance with the curvature of the cable, even when the cable is in a highly curved, for example helical, position in relation to the course of the pipe. The object is achieved by clamping elements secured on the holding element such that they are rotatable about a radial axis of the pipe. With a cable fed into a claming according to the invention, buckling points along the curved course of the cable are prevented. Bending and tensile forces are taken up more effectively. The mechanical load on both the cable and the clamping element is greatly reduced. It is not necessary to aim for an axially parallel course of the cable. Obstacles within the pipe can be virtually by-passed without difficulty.

In an advantageous embodiment of the invention, the holding element, on which at least one clamping element is rotatably secured, may be clamped in the inside circumference of the pipe. The holding elements are thus installed in simple manner, without the inside pipe-wall being damaged or weakened by fixing means. The axial spacings between the clampable spring elements may be freely selected and do not require pre-planning and preparatory work on the inside of the pipe. As a result, there are no problems relating to the cable holding means when dealing with alterations, large fittings occupying virtually the entire circumference of the pipe, or junction points. For a plurality of cables or cable bundles, the holding elements can be provided with a plurality of clamping elements.

A further advantageous embodiment is realised by securing the holding element on the inside pipe-wall. In this screwed variant, the holding element can be of a very small construction, as a result of which the space inside the pipe is reduced only insubstantially. In principle, the clamping element can also be rotatably secured directly on the inside pipe-wall.

According an advantageous further development, the pipe is constructed as a sewage pipe which may be laid underground and has peripheral connections. In the case of such sewage pipes, which are often also used for laying telecommunications cables, power-supply cables or for smaller pipes laid inside the pipe for the purpose of conveying fluid media, it is necessary to watch for unauthorized manipulation. To this end, it is possible to lay individual glass-fibre cables on the inside of the pipe, which, at particularly sensitive points (in particular opening flaps), function as indicators as a result of changes in attenuation caused by manipulation. Glass-fibre cables of this type often have to be installed in a highly curved arrangement, for which the cable holding means described above is particularly suitable.

### BRIEF DESCRIPTION OF THE DRAWINGS

The invention is explained in more detail below with reference to illustrated Figures:

FIG. 1 shows a pipe having a first variant of a cable holding means,

FIG. 1a shows an enlarged detail of FIG. 1,

FIG. 2 shows a pipe having a second variant of a cable holding means,

FIG. 2a shows an enlarged detail of FIG. 2 and

FIG. 3 shows a longitudinal section through a pipe having a cable arrangement.

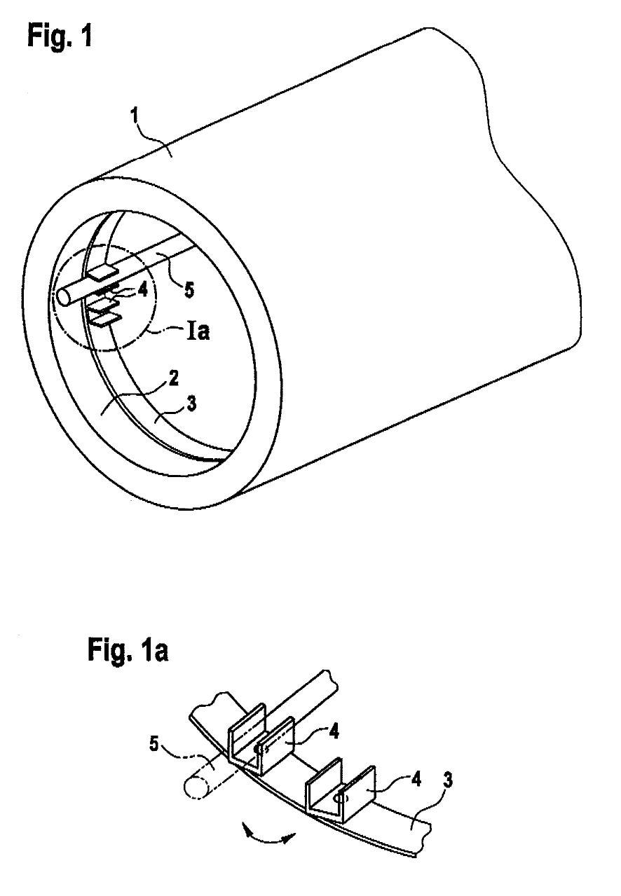

FIG. 1 shows a pipe 1, in the inside wall 2 of which a holding element in the form of a spring element 3 is clamped. A plurality of inwardly protruding clamping elements 4, of which two are illustrated, are secured on the spring element 3 for the purpose of receiving a cable 5. The clamping element 4 is connected to the spring element 3 such that it is able to rotate about a radial pipe axis. As a result, the cable clamping point can be readily adapted to any non-axially parallel longitudinal course of the cable 5 to be laid.

FIG. 1a shows, in detail, a clamping element 4 which is rotated with respect to the spring element 3 in order to prevent the cable 5 from buckling at the clamping point. Furthermore, as a result of the rotated clamping element 4, the tensile and bending forces are taken up effectively and the cable 5 is consequently prevented from springing out of the clamping element 4.

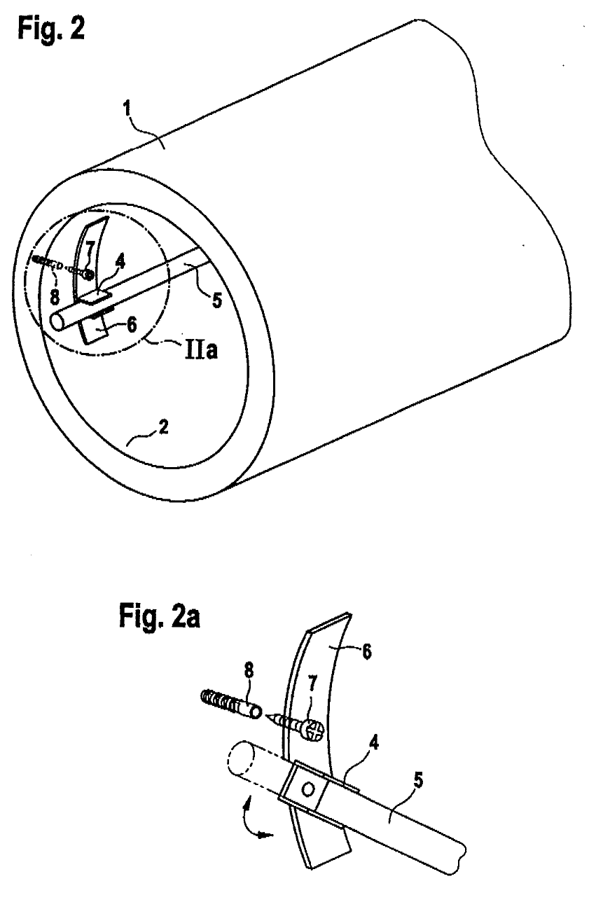

The second variant (illustrated in FIGS. 2 and 2a) of a cable holding means differs from the first variant according to FIGS. 1 and 1a in terms of the construction of the holding element. The spring element 3 which may be clamped in the inside circumference of the pipe 1 is replaced by a holding means 6 which is secured on the inside wall 2 of the pipe 1 by means of screws 7 and optionally pegs 8. As a result of its small size, the holding means 6 only slightly restricts the space which is available inside the pipe 1 for other uses.

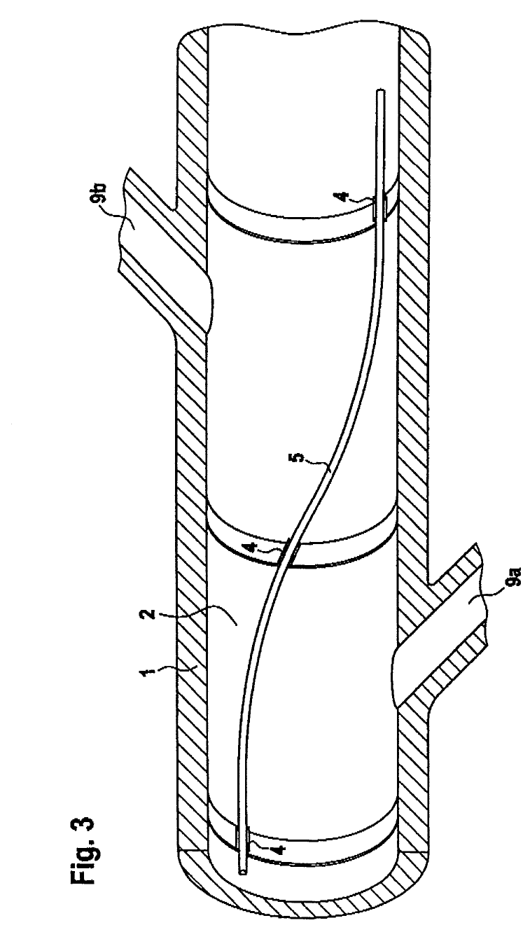

FIG. 3 shows a cable arrangement in which pipe inlets and outlets, 9a and 9b respectively, are virtually by-passed. It may be necessary to lay the cable 5 in a tightly wound or very wavy or even helical manner as a result of fittings within the pipe or other types of obstacle. Here, the rotatable clamping elements 4 are adapted to each direction of the cable, even when this deviates greatly from the axial direction of the pipe.

The invention is not restricted to the exemplary embodiments described above; instead a number of variants are conceivable, these making use of the features according to the invention in essentially different embodiments.

A cable holding means within a pipe having at least one holding element, which is secured on the inside wall of the pipe, and at least one clamping element, which is secured on the holding element for the purpose of receiving the cable or the cable bundle, wherein the clamping element is secured on the holding element such that it is rotatable about a radial axis of the pipe.

2. A cable holding means according to claim 1, wherein the holding element is constructed as a spring element which may be clamped in the inside wall of the pipe.

3. A cable holding means according to claim 1, wherein the holding element is constructed such that it may be screwed into the inside wall of the pipe.

4. A cable holding means according to claim 1, characterised in that the pipe is constructed as a sewage pipe which may be laid underground and has peripheral connections, in particular pipe inlets and outlets.
